(19) United States
(12) Patent Application Publication
(10) Pub. No.: US 2003/0020046 A1
(43) Pub. Date: Jan. 30, 2003

(54) Polyvinyl alcohol stabilised polymerisate for improving the optimal brightening of coating materials

(76) Inventors: Reinhold J. Leyrer, Dannstadt (DE); Harutyun Hanciogullari, Limburgerhof (DE)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/168,138

(22) PCT Filed: Dec. 6, 2000
(86) PCT No.: PCT/EP00/12273

(30) Foreign Application Priority Data
Dec. 17, 1999 (DE) 199 60 863.6

(51) Int. Cl. C09K 11/02

(52) U.S. Cl. 252/301.21; 252/301.16; 252/301.35

(57) ABSTRACT

An aqueous composition contains a polymer dispersed in water with polyvinyl alcohol as a protective colloid (abbreviated to PVA-dispersed polymer) and a fluorescent or phosphorescent dye.

The present invention relates to an aqueous composition containing a polymer dispersed with polyvinyl alcohol as protective colloid in water (abbreviated to PVA-dispersed polymer) and a fluorescent or phosphorescent dye.

The present invention furthermore relates to the use of the composition as a coating or impregnating material, in particular as a paper coating slip or surface coating, in textile printing or as an additive for detergents.

Aqueous coating or impregnating materials frequently contain fluorescent dyes as optical brighteners for improving the visual color properties of the products produced using these materials. It is known that the effect of optical brighteners can be improved by adding water-soluble polymers.

EP-A-624687 also mentions polyvinyl alcohol for this purpose.

EP-A-44995 states that water-insoluble optical brighteners can be dispersed in water with the aid of graft polymers of polyvinyl alcohol.

The use of polyvinyl alcohols as a protective colloid in emulsion polymerization is disclosed in EP-A-863163 and EP-A-627450.

It is an object of the present invention to improve the effect of optical brighteners, in particular to achieve equally good effects with smaller amounts of the optical brighteners.

At the same time, however, the performance characteristics of the coating or impregnating material should not be adversely affected but, if possible, should be further improved.

In particular, it is also desirable to simplify the composition and the preparation of coating and impregnating materials, in particular to reduce the number of components required.

We have found that this object is achieved by the aqueous composition defined at the outset and its use as a coating or impregnating material, in textile printing or as an additive for detergents.

The novel composition contains a polymer dispersed with polyvinyl alcohol (PVA) as a protective colloid (abbreviated to PVA-dispersed polymer).

PVA is understood as meaning a polymer which comprises at least 10, in particular at least 20, % by weight, based on the polymer, of groups of the formula

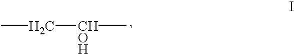

which are derived from vinyl alcohol.

Usually, polyvinyl alcohols are obtained by hydrolyzing polyvinyl esters, in particular polyvinyl acetate. In addition to the structural units derived from vinyl alcohol, the PVA can therefore also contain unhydrolyzed structural units derived from vinyl ester. The PVA preferably contain

from 30 to 100, particularly preferably from 50 to 100, % by weight of groups of the formula I,

from 0 to 70, particularly preferably from 0 to 50, % by weight of structural units derived from vinyl esters and, if required, from 0 to 40% by weight of other structural units.

Preferably, the polyvinyl alcohol has a viscosity of from 0.1 to 100, in particular from 0.1 to 30, particularly preferably from 0.5 to 8, mPas, measured in a 4% strength by weight solution of the polyvinyl alcohol in water at 20° C. (according to DIN 53015).

The preparation of the PVA-dispersed polymers can be carried out by polymerization of starting compounds (monomers) capable of free radical polymerization, in the aqueous phase in the presence of PVA.

Preferably, the polymerization is effected in the presence of at least 0.5 part by weight, particularly preferably at least 2, very particularly preferably at least 26, in particular at least 40, parts by weight, based on 100 parts by weight of monomers, of PVA. In general, however, not more than 250, preferably not more than 150, particularly preferably not more than 100, parts by weight, based on 100 parts by weight of monomers, of PVA are used.

Usually, the PVA is initially taken in the aqueous phase. In addition to PVA, other protective colloids and emulsifiers may also be used.

The polymerization can be carried out according to the generally known emulsion polymerization method.

In the emulsion polymerization, the monomers can be polymerized as usual in the presence of a water-soluble initiator, of the PVA and, if required, of further protective colloids and emulsifiers at, preferably, from 30 to 140° C.

Examples of suitable initiators are sodium persulfate, potassium persulfate and ammonium persulfate, tert-butyl hydroperoxides, water-soluble azo compounds or redox initiators, such as H₂O₂/ascorbic acid.

Additional protective colloids and emulsifiers are, for example, alkali metal salts of relatively long-chain fatty acids, alkyl sulfates, alkanesulfonates, alkylated arylsulfonates, alkylated biphenylethersulfonates, relatively long-chain fatty alcohols and the corresponding alkoxylated products of said sulfates, sulfonates and alcohols.

The PVA-dispersed polymer is preferably composed of the monomers below. The stated weights are based in each case on the total amount of the monomers of which the PVA-dispersed polymer is composed.

The PVA-dispersed polymer may be used as a binder. The PVA-dispersed polymer contains, as a binder, preferably main monomers selected from C₁- to C₁₆-alkyl (meth)acrylates, vinylaromatics of up to 20 carbon atoms, vinyl esters of carboxylic acids of 1 to 20 carbon atoms, vinyl halides, ethylenically unsaturated nitriles, nonaromatic hydrocarbons having one or two conjugated double bonds or mixtures of these monomers. Examples are alkyl (meth)acrylates having a C₁-C₁₀-alkyl radical, such as methyl methacrylate, methyl acrylate, n-butyl acrylate, ethyl acrylate and 2-ethylhexyl acrylate.

Mixtures of the alkyl (meth)acrylates are also particularly suitable.

Suitable vinyl esters of carboxylic acids of 1 to 20 carbon atoms are, for example, vinyl laurate, vinyl stearate, vinyl propionate and vinyl acetate.

Suitable vinylaromatic compounds of up to 20 carbon atoms are vinyltoluene, α-butylstyrene, 4-n-butylstyrene, 4-n-decylstyrene and preferably styrene. Examples of ethylenically unsaturated nitrites are acrylonitrile and methacrylonitrile.

Vinyl halides are chlorine-, fluorine- or bromine-substituted ethylenically unsaturated compounds, preferably vinyl chloride and vinylidene chloride.

Examples of nonaromatic hydrocarbons having one or two conjugated olefinic double bonds are butadiene, isoprene and chloroprene as well as ethylene.

In addition to the main monomers, the PVA-stabilized polymer may also contain further monomers, for example hydroxyl-containing monomers, such as hydroxyalkyl acrylates or monomers having alkoxy groups, as obtainable by alkoxylation of hydroxyl-containing monomers with alkoxides, in particular ethylene oxide or propylene oxide, monomers having acid or anhydride groups or salts thereof, e.g. (meth)acrylic acid, maleic acid or vinylsulfonic acid.

The PVA-stabilized polymer preferably comprises at least 20, particularly preferably at least 35, very particularly preferably at least 50, % by weight of the main monomers.

The PVA-dispersed polymer can also be used as a thickener.

When used as a thickener, the PVA-dispersed polymer preferably contains at least 5, particularly preferably at least 15, very particularly preferably at least 30, % by weight of monomers having at least one acid group (abbreviated to acid monomers). In general, the PVA-dispersed polymer contains not more than 80, in particular not more than 60, particularly preferably not more than 50, % by weight of the acid monomers.

When used as a thickener, the PVA-dispersed polymer may contain in particular the main monomers and further monomers described above, in addition to the acid monomers.

At least some of the acid groups of the PVA-dispersed polymer, when used as a thickener, are neutralized, preferably before the subsequent use. Preferably, at least 30 mol %, particularly preferably from 50 to 100%, of the acid groups are neutralized. Suitable bases are volatile bases, such as ammonia, or nonvolatile bases such as alkali metal hydroxides.

The PVA-dispersed polymer obtained after the polymerization can, if desired, readily be spray-dried.

Flowable polymer powder having the abovementioned content of PVA protective colloid are obtained. The powders are readily redispersible in water, so that the novel aqueous composition can be reconstituted at any time.

In addition to the PVA-dispersed polymer, the novel aqueous composition contains a fluorescent or phosphorescent dye. Fluorescent dyes, in particular optical brighteners, are preferred. Optical brighteners are fluorescent dyes which increase the brightness and, in white coated papers, for example, the whiteness.

Known optical brighteners are in particular stilbene derivatives.

In the present case, optical brighteners having a water solubility of at least 1 g, in particular at least 5 g, per liter of water (at 20° C.) are preferred.

In a preferred embodiment of the invention, the aqueous composition contains, in addition to the PVA present as protective colloid, also PVA which is dissolved in the aqueous phase. This additional PVA may be added at any time, for example to the aqueous phase after the preparation of the PVA-dispersed polymer.

Based on the total amount of PVA contained in the aqueous composition, this comprises preferably from 5 to 100, particularly preferably from 20 to 100, very particularly preferably from 30 to 100, % by weight of PVA as protective colloid in the PVA-dispersed polymer and from 0 to 95, particularly preferably from 0 to 80, very particularly preferably from 0 to 70, % by weight of PVA additionally dissolved in water. In particular, more than 50% by weight of the total amount of PVA, or the total amount of PVA, may be present as collective colloid.

The novel composition has a very wide range of intended uses. The PVA-dispersed polymer can be used, for example, as a binder or, preferably, as a thickener.

The composition can be added, for example, as an additive to detergent, or used as an assistant in the dyeing of textiles.

It may also be used, for example, as an aqueous coating or impregnating material, in particular as a paper coating slip or surface coating.

The novel composition enhances the effect of the fluorescent or phosphorescent dye and produces optical brightening.

The fluorescent or phosphorescent dye present in the composition is activated by PVA. The activation and the resulting optical brightener is substantially increased in comparison with the aqueous systems which do not contain PVA as a protective colloid of a polymer, in particular of the thickener.

Depending on the intended use, the novel composition may contain further components.

When used as a coating or impregnating material, the aqueous compositions contain in particular

a) if required, one or more binders,

b) if required, a thickener,

c) an optical brightener and

d) if required, pigments and fillers,

at least one PVA-dispersed polymer being present as binder a) or thickener b) in the composition.

If the coating material is a paper coating slip or surface coating, preferably all four components a) to d) are present.

Paper coating slips and surface coatings contain one or more binders a), these preferably being polymers which are obtained by pure radical polymerization method and overall preferably comprise at least 30, particularly preferably at least 50, % by weight of the abovementioned main monomers. In paper coating slips, these are in general C₁-C₁₆-alkyl (meth)acrylates or mixtures thereof with vinylaromatics, in particular styrene, or alternatively are nonaromatic hydrocarbons having two conjugated double bonds, in particular butadiene, or mixtures thereof with vinylaromatics, in particular styrene.

Particularly in the case of paper coating slips, it has proven advantageous to combine binders of different compositions (binder and cobinder) as described in EP 14904.

Suitable thickeners b) in addition to polymers obtained by free radical polymerization method are conventional organic and inorganic thickeners, such as hydroxymethylcellulose or bentonite.

Preferably, the thickener or one of the cobinders is the PVA-dispersed polymer.

In the case of the paper coating slips, pigments or fillers d) are in general white pigments, e.g. titanium dioxide. In the case of surface coatings, they may be the conventional colored pigments and fillers in addition to white pigments.

When it is used as a paper coating slip or surface coating, the novel aqueous composition preferably has the following composition by weight.

Paper coatings:

a) from 1 to 40 parts by weight of binder (solid, i.e. without water)

b) from 0.1 to 10 parts by weight of thickener (solid, i.e. without water)

c) from 0.1 to 5 parts by weight of fluorescent or phosphorescent dye

d) based on 100 parts by weight of the total amount of the pigments and fillers.

Surface coating (volume data are usual here):

a) from 20 to 95 parts by volume of binder

b) from 0.5 to 10 parts by volume of thickener

c) from 0.05 to 5 parts by volume of optical brightener, based on

d) 100 parts by volume of the total amount of pigments and fillers.

The total amount of the PVA contained in the coating or impregnating material, for example paper coating slips and surface coatings, is preferably from 0.05 to 50, particularly preferably from 0.1 to 5, parts by weight of PVA, based on 100 parts by weight of the total amount of the components a) to d). The preferred distribution over PVA as protective colloid and additionally dissolved PVA is as stated above.

From the above amounts of the components a) to d) it is also evident that the amount of PVA initially taken in the emulsion polymerization depends on whether the PVA-dispersed polymer obtained is subsequently used as a binder or thickener. In the case of the binder, the amount of PVA desired in the subsequent coating material can be achieved with only very small amounts of PVA as protective colloid, since the amount of binder is much greater than conventional amounts of thickener.

In the case of the coating and impregnating materials, good water retention is observed in addition to the improved optical brightening. This prevents excessively rapid absorption of water during the coating of absorbent substrates, e.g. paper.

### EXAMPLES

A) Preparation of Paper Coating slips

I Base Formulation:

A paper coating slip was prepared from the following components:

70.0 parts by weight of the pigment Hydrocarb 90, finely divided chalk from Omya GmbH, Brohler Straβe 11a, D-50968 Cologne,

30.0 parts by weight of the pigment Amazon 88, finely divided clay from Kaolin International B. V., KAAI 54 DD, B-2030 Antwerp (97.5% strength)

0.1 part by weight of sodium hydroxide solution (25% strength)

0.3 part by weight of Polysalt S from BASF Aktiengesellschaft, D-67056 Ludwigshafen (45% strength)

10.0 parts by weight of Acronal® S360D from BASF (50% strength), a binder based on acrylates and styrene

0.45 part by weight of Blankophor® PSG from Bayer AG, D-5090 Leverkusen 1 (45% strength), a stilbene derivative containing sulfonate and triazine groups

The solids content was brought to 67% by weight with water and the pH to 8.9-9.1 with sodium hydroxide solution.

II Addition of a Cobinder to the Base Formulation

a) 1.5 parts by weight, based on 100 parts by weight of pigment, of Acrosol® B 37 D (solid), a polyacrylate from BASF, were added.

b) 1.5 parts by weight (solid), based on 100 parts by weight of pigment, of a mixture of Acrosol B37D and polyvinyl alcohol (PVA) were added.

Preparation of the Mixture:

300 g of 30% strength Acrosol B37D are introduced into a 1 l glass beaker and stirred with an anchor stirrer (120 rpm) at room temperature. At the same time, 180 g of a 15% strength polyvinyl alcohol (Moviol 4/88, Hoechst AG 67 mPa.s of a 10% strength solution in demineralized water, pH 5.3) are prepared in a separate vessel with gentle heating, added to the 1 l glass beaker and stirred for a further 10 minutes. For stabilization purposes, 10 ppm of the biocide Kathon LXE are stirred in.

c) 0.5 part by weight (solid), based on 100 parts by weight of pigment, of a PVA-dispersed polymer is added.

Preparation of the PVA-Dispersed Polymer

556 g of demineralized water, 75 g of polyvinyl alcohol (Moviol 4/88) and 1.25 g of the iron catalyst Dissolvine E-FE-13 (1% strength) are initially taken in a stirred apparatus consisting of a 2 liter four-necked flask with paddle stirrer (180 rpm), reflux condenser, internal thermal couple and metering station and are heated to 75° C. The polyvinyl alcohol dissolves during heating-up.

5 ml of a 2.5% strength sodium persulfate solution are added at 75° C. to this solution, and the mixture is stirred at 75° C. for 5 minutes. Thereafter, the monomer mixture (100 g of acrylonitrile, 100 g of ethyl acrylate, 50 g of acrylic acid, 1.5 g of tertiary dodecyl mercaptane 16.67 g of Steinapol NLS (sodium laurylsulfate) and 240 g of demineralized water), 45 g of a 2.5% strength sodium persulfate solution and 47 g of a 0.8% strength ascorbic acid solution (Lutavit C) are metered in uniformly in the course of 3 hours at 75° C. with further stirring. The reaction mixture is then stirred for a further 15 minutes at 75° C. and then brought to room temperature. At room temperature, 20 g of a 2.5% strength hydrogen peroxide solution with 20 g of a Lutavit C solution are metered in uniformly in the course of 1 hour. An aqueous polymer dispersion having a solids content of 25% is obtained.

III Addition of a Thickener to the Base Formulation

a) 1.5 parts by weight, based on 100 parts by weight of pigment (solid), of Sterocoll® PR 8749 X (solid), a thickener based on acrylates, are added.

b) 0.3 parts by weight, based on 100 parts by weight of pigment, of a PVA-dispersed polymer (solid) is added as thickener.

Preparation of the PVA-Dispersed Polymer

The experiment set up corresponds to that under IIc. 730 g of demineralized water and 90 g of Rhodoviol R 4/20 (Rhône-Poulenc GmbH 85 mPa.s 10% strength/pH 5.3) are initially taken and are heated to 85° C. 3.6 ml of a 1% strength sodium persulfate solution are added to this solution at 85° C., and the mixture is stirred at 85° C. for 5 minutes. Thereafter, at 85° C., with further stirring, the monomer mixture (100.8 g of ethyl acrylate, 19.8 g of acrylic acid, 69.4 g of methacrylic acid, 0.18 g of tertiary dodecyl mercaptan, 6 g of Steinapol NLS (sodium laurylsulfate) and 176 g of demineralized water) and 32.4 g of a 1% strength sodium persulfate solution are metered in uniformly in the course of 2 hours and 43 g of a 0.25% strength ascorbic acid solution (Lutavit C) in the course of 2.25 hours. The reaction mixture is then brought to room temperature. At room temperature, 0.09 g of Dissolvine E-FE-13 (1% strength) and 6 g of a 3% strength hydrogen peroxide solution are added to the chemical aftertreatment. 27 g of a 1% strength Lutavit C solution are then metered in over 30 minutes. An aqueous polymer dispersion having a solids content of 20% is obtained.

c) 0.3 parts by weight (solid), based on 100 parts by weight of pigment, of a mixture of PVA-dispersed polymer and additional PVA is added.

Preparation of the Mixture:

The procedure corresponded to III b, with the following modifications:

802 g of demineralized water and 54 g of polyvinyl alcohol Rhodoviol R4/20 are initially taken and are heated to 85° C.

After the end of the ascorbic acid feed, a further 64 g of Rhodoviol R4/20 are added and washed with 50 g of demineralized water.

IV Addition of a PVA Stabilized Cobinder in Powder Form to the Base Formulation.

0.5 parts by weight, based on 100 parts by weight of pigment, of the powder is added.

Preparation of the Powder

The preparation was carried out according to IIc, with the following modifications:

Modification:

732 g of demineralized water and 50 g of polyvinyl alcohol (Rhodoviol R8/20, Rhône-Poulenc GmbH, 179 mPa.s, 10% strength/pH 5.6) are initially taken and are heated to 75° C. The monomer mixture is metered in without Steinapol NLS (sodium lauryl sulfate). An aqueous polymer dispersion having a solids content of 25% is obtained and is subsequently spray-dried. The spray-dried powder has a residual moisture content of about 2% and has an unlimited shelf-life.

B. Coating of the Papers and Test Results Production of the coated paper

The base paper used was a wood-free coating paper from Scheufelen GmbH+Co.KG, D-73250 Lenningen, having a basis weight of 70 g/m². The paper coating slip was applied on one side in a dry coat thickness of 12 g/m² on a laboratory coating machine by means of a blade. The applied moist coat was dried using IR lamps.

Determination of the Water Retention According to Gradek

The water retention was measured in an AA-GWR pressure filtration apparatus from Abo Akademi-Gravimetric Water Retention, which was obtained from OY Gradek AB, Mariantie 9, SF-02700 Kauniainen, Finland. The filter used was a 100/Pk polycarbonate membrane, 5.0 μm-pore size, 47 mm diameter, of Osmonics Inc., which was obtained from Infiltec GmbH, Alte Rheinhauser Straβe 8, D-67346 Speyer/Rhein. The paper used was ashless Schwarzband filter paper, 90 mm diameter from Schleicher & Schuell, Postfach 4, D-3354 Dassel.

The apparatus was connected to a compressed air line and a pressure of 4 bar was set. Five weighed filters stapled together were placed on the rubber sheet, it being necessary to ensure that the fifth filter is still dry after the measurement. If not, then it should be increased to 8 or 10. These are followed by a polycarbonate membrane, slightly projecting, and the metal cylinder with the rubber seal at the top. The stopper was closed by means of the lever. A pressure of 0.5 bar was set by pulling out the pressure adjustment knob. About 5 ml of paper coating slip were introduced into the metal cylinder. A pressure of 0.5 bar was applied for 60 seconds. The wet filter papers were weighed again. The moisture absorption was multiplied by 1250. The result is the amount of water released, in g/m².

The smaller the amount released, the better is the water retention of the paper coating slip (cf. Table 1).

Determination of the Optical Brightening

The optical brightening was determined using an Elrepho 2000 spectrophotometer from Datacolor GmbH (D-45769 Marl).

The papers to be tested were stacked in groups of at least 4.5 measurements were carried out per paper sample.

The values stated in Table 1 are a measure of the brightening.

The higher the value, the greater is the brightening.

| | Parts by weight | | | | |
|---|---|---|---|---|---|
| | of PVA, based on | Parts by weight | Parts by weight | | |
| | 100 parts by | of added | of PVA, based on | | |
| | weight of the | dispersion, based | 100 parts by | | Water retention |
| | added dispersion¹ | on 100 parts by | weight of pigment | Optical | amount of water |
| Example | (solid) | weight of pigment | (solid) | brightening | released, in g/m² |
| IIa* | 0 | 1.5 | 0.00 | 5.3 | 158 |
| IIb* | 30 | 1.5 | 0.45 | 6.2 | 164 |
| IIc | 30 | 0.5 | 0.15 | 6.2 | 109 |
| IIIa* | 0 | 1.5 | 0.00 | 5.0 | 126 |
| IIIb | 50 | 0.3 | 0.15 | 6.0 | 126 |
| IIIc | 65 | 0.3 | 0.20 | 6.0 | 131 |
| IV | 20 | 0.5 | 0.10 | 5.8 | 129 |

* for comparison
¹added dispersion is understood in each case as meaning the cobinder or thickener dispersion added in Examples IIa to IV to the base formulation

We claim:

1. An aqueous composition containing a polymer dispersed with polyvinyl alcohol as protective colloid in water (abbreviated to PVA-dispersed polymer) and a fluorescent or phosphorescent dye.

2. An aqueous composition as claimed in claim 1, wherein the polyvinyl alcohol comprises at least 10% by weight of groups —H₂C—CH(OH)—.

3. An aqueous composition as claimed in claim 1 or 2, wherein the polyvinyl alcohol has a viscosity of from 1 to 100 mPa.s, measured according to DIN 53015 in a 4% strength by weight aqueous solution of the polyvinyl alcohol at 20° C.

4. An aqueous composition as claimed in any of claims 1 to 3, wherein the preparation of the PVA-dispersed polymer is carried out by polymerization of the starting compounds (monomers) capable of free radical polymerization in the aqueous phase in the presence of from 0.5 to 250 parts by weight, based on 100 parts by weight of the monomers to be polymerized, of polyvinyl alcohol as protective colloid.

5. An aqueous composition as claimed in any of claims 1 to 4, wherein the PVA-dispersed polymer is composed of at least 5% by weight of monomers having an acid group.

6. An aqueous composition as claimed in any of claims 1 to 5, wherein the PVA-dispersed polymer comprises at least 20% by weight of main monomers selected from C₁- to C₁₆-alkyl (meth)acrylates, vinylaromatics of up to 20 carbon atoms, vinyl esters of carboxylic acids of 1 to 20 carbon atoms, vinyl halides, ethylenically unsaturated nitrites, nonaromatic hydrocarbons having one or two conjugated double bonds or mixtures of these monomers.

7. An aqueous composition as claimed in claim 6, wherein the PVA-dispersed polymer comprises altogether at least 30% by weight of C₁- to C₁₆-alkyl (meth)acrylates and vinylaromatics of up to 20 carbon atoms or mixtures thereof.

8. An aqueous composition as claimed in claim 6, wherein the PVA-dispersed polymer comprises at least 30% by weight of nonaromatic hydrocarbons having two conjugated double bonds and vinylaromatics of up to 20 carbon atoms or mixtures thereof.

9. An aqueous composition as claimed in any of claims 1 to 8, wherein the fluorescent or phosphorescent dye has a water solubility greater than 1 g per liter of water at 20° C.

10. An aqueous composition as claimed in any of claims 1 to 9, wherein the fluorescent or phosphorescent dye is an optical brightener.

11. An aqueous composition as claimed in any of claims 1 to 10, containing
a) if required, one or more binders,
b) if required, a thickener,
c) a fluorescent or phosphorescent dye and
d) if required, pigments and fillers,
wherein at least one PVA-dispersed polymer is present as binder a) or thickener b) in the composition.

12. An aqueous composition as claimed in claim 11, wherein the thickener is a PVA-dispersed polymer.

13. An aqueous composition as claimed in either of claims 11 and 12, wherein the composition contains from 0.05 to 50 parts by weight, based on 100 parts by weight of the total amount of the components a), b), c) and d), of polyvinyl alcohol.

14. An aqueous composition as claimed in any of claims 1 to 13, wherein the composition contains from 5 to 100% by weight of polyvinyl alcohol present as a protective colloid and from 0 to 95% by weight of polyvinyl alcohol dissolved in water, based on the total amount of polyvinyl alcohol.

15. The use of an aqueous composition as claimed in any of claims 1 to 14 as a coating material or impregnating material.

16. The use of an aqueous composition as claimed in any of claims 1 to 14 as a paper coating slip or surface coating.

17. The use of an aqueous composition as claimed in any of claims 1 to 14 as an additive for detergents.

18. The use of an aqueous composition as claimed in any of claims 1 to 14 for textile printing.

19. A substrate coated or impregnated with an aqueous composition as claimed in any of claims 1 to 14.

20. The use of polymers dispersed in aqueous phase with polyvinyl alcohol as protective colloid (PVA-dispersed polymers) for optical brightening.

21. The use as claimed in claim 20, wherein the preparation of the PVA-dispersed polymer is carried out by polymerization of the starting compounds (monomers) capable of free radical polymerization, in the aqueous phase in the presence of from 0.5 to 250 parts by weight, based on 100 parts by weight of the monomers to be polymerized, of polyvinyl alcohol as protective colloid.

22. The use as claimed in any of claims 15 to 21, wherein the aqueous composition is wholly or partly neutralized with a base before its use.
